(19) United States
(12) Patent Application Publication
(10) Pub. No.: US 2010/0145997 A1
(43) Pub. Date: Jun. 10, 2010

(54) User driven ad-hoc permission granting for shared business information

(75) Inventors: Yariv ZUR, Kfar-Saba (IL); Guy BAVLY, Herzlia (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: SAP Portals Israel Ltd, Raanana (IL)

(21) Appl. No.: 12/329,637

(22) Filed: Dec. 8, 2008

(51) Int. Cl. G06F 17/30; G06F 7/00

(52) U.S. Cl. 707/783; 707/E17.005

(57) ABSTRACT

An apparatus and method for sharing information between a person having certain permissions, and another person or group of persons having insufficient permissions for the information. The apparatus and method enable a creator of a report to grant people or groups ad-hoc access permission to object types and object instances for which they have no a-priori permission. The method and apparatus enable the shared information to be up-to-date rather than static, and in addition enables logging and tracking of accesses to the information. The permission can have properties such as expiration date, context limitation, or further granting permission to a third party.

### TECHNICAL FIELD

The present invention relates to business applications in general, and to an apparatus and method for granting ad-hoc permissions for sharing information between users, in particular.

### BACKGROUND

In today's business world, sharing information is an everyday necessity, in all disciplines and all levels, and particularly in the business world. Employees share information with people outside their organization, as well as with people within the organization, comprising for example supervisors, subordinates, peers, parallels, or others. For example, a team leader may want to share information with a parallel and ask for advice concerning an issue the two of them may have encountered, a worker would like to point out a problem, or similar situations.

However, the person or persons with whom the originator of the information would like to share the information, do not necessarily have the same permissions for viewing or acting upon the relevant data. For example, two parallel team leaders may have the same permission levels, but each team leader can view only data relating to his or her team, and not to the other's.

Current methods for sharing information from computerized systems comprise taking a snapshot of the information, whether as a printed document, or using a soft medium such as a static report stored on a media, sent by e-mail, or the like. This approach suffers from a number of drawbacks. First, once handed, sent, or otherwise given to a person, the originator of the information no longer has control over the media, and the information can leak to any direction, including persons or entities within or outside the organization who do not have the appropriate privileges to view the information. In addition to not being able to control the spreading of the information, the originator may not even be able to assess the involved risk, since there is no record of where the information has leaked to, which is a serious problem for security conscious organizations.

Another drawback relates to the information becoming stale, i.e. not up-to-date by the time it is being viewed by the intended recipient or by others, thus potentially making the issue raised by the person irrelevant.

Yet another solution for sharing information in general, and within or organizations in particular, requires the cooperation of information technology (IT) people of the organization, in granting permissions to people regarding confidential data, upon demand. This solution, however, is not instantaneous, consumes precious time in explaining the requirements to the IT people, and optionally requires also the removal of such permission at a later time or after a certain action took place.

There is thus a need in the art for a method and apparatus for granting ad-hoc permission, in order to enable information flow and sharing within an organization. The method and apparatus should thus provide the option to share live information with people who were specifically granted permission to view or act upon the information. In addition, the method and apparatus should provide audit trail generation, for tracing and controlling granted permissions.

### SUMMARY

An apparatus and method for sharing information between a person having certain permissions, and another person or group of persons having insufficient permissions for the information. The apparatus and method enable a creator of a report to grant people or groups ad-hoc access permission to object types and object instances for which they have no a-priori permission. The method and apparatus enable the shared information to be up-to-date rather than static, and in addition enables logging and tracking of accesses to the information. The permission can have properties such as expiration date, context limitation, or further granting permission to a third party.

A first aspect of the disclosure relates to a method for sharing information between users of a computerized system, the method comprising the steps of: receiving a description of a report comprising one or more fields; receiving a recipient list of the report; a permission analysis step, comprising: determining one or more object types or object instance associated with the fields; determining one or more recipients from the recipient list that have insufficient permission for the object types or object instances; providing a visual indication of the fields; receiving an approval for granting a permission to the recipient for the fields or for the object types or object instances; associating the permission with the report; storing the permission in association with the object type or object instance; logging the permission; and presenting the report to the recipient, including the fields. The method can further comprise the step of storing the permission in association with the object types or object instances. The method can further comprise the step of storing the permission in association with the object types or object instances. The method can further comprise the step of logging access details of the recipient to the object types or object instances. Within the method, the visual indication optionally indicates the recipients. Within the method, the permission is optionally associated with a property. Within the method, the property is optionally selected from the group consisting of: expiration date; usage limitation; transfer rights; and context limitation. The method can further comprise the step of receiving further permission granting from the recipient to a third party. Within the method, the permission is optionally provided ad-hoc.

Another aspect of the disclosure relates to an apparatus for sharing information between users of a computerized system, the users having different permissions, the apparatus comprising: user interface components for providing and receiving information to and from a user of the apparatus, the user creating or viewing a report; communication components for communicating with external systems; a permission verification component for determining one or more object types or object instances for which a recipient of the report does not have sufficient permission; a storage device for storing the permission; and a permission logging component for logging the permission on the storage device. The apparatus can further comprise a component for storing the permission in a storage device associated with the computerized system. The apparatus can further comprise a component for associating the permission granted to the recipient for the object types or object instances, with the report. Within the apparatus, the communication components optionally comprise one or more components for communicating with a system selected from the group consisting of: a database; a report creation system; and an e-mail system. Within the apparatus, the user-interface components optionally comprise one or more components selected from the group consisting of: recipient list handler; missing permission indication handler; and approve or deny permission handler. The apparatus can further comprise a permission association with report component, for associating a permission granted to the recipient for the object types or object instances, with the report.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a block diagram of the object structure in a typical organizational computing system;

FIGS. 2A and 2B are illustrations of exemplary user interfaces for granting permissions, in accordance with the disclosure;

FIG. 3A is a flowchart of the main steps in a method for granting ad-hoc permission, in accordance with the disclosure;

FIG. 3B is a flowchart of the main steps in a method for viewing reports associated with ad-hoc granted permissions, in accordance with the disclosure; and

FIG. 4 is a block diagram of the main components in an apparatus for granting ad-hoc permissions, in accordance with the disclosure.

### DETAILED DESCRIPTION

An apparatus and method for granting users ad-hoc permissions for data in an enterprise computerized system.

In accordance with the disclosure, a user of an enterprise computerized system creates or views a new or an existing report or another data action or representation entity, which he would like to share with other people. The representation entity is created using a system, module, or component adapted for creating such entities. Such representation entity may be a report, an application UI or the like. For simplicity, the disclosure relates to a report, but it will be appreciated that the disclosure is valid to any representation and action entity. When creating or viewing a report, in addition to creating or viewing the text, graphics, tables or other parts of the report, the creator or receiver of the report user also indicates which people or group of people, such as members of a particular team, the report is intended to. The report is not limited to presenting data but can also be used for performing activities, such as adding, deleting or updating data related to objects within the organization.

The report creation or viewing system then indicates which permissions are missing for one or more of the intended recipients for fully viewing or otherwise using the report. The missing permissions can be indicated in a variety of ways. In one embodiment, when the user hovers with a pointing device, or otherwise indicates a part of the report, a list of the people or groups and the missing permissions for these people or groups is presented on a pop-up window, a separate pane, or in a dedicated part of the screen.

In an alternative embodiment, when the user hovers, clicks or otherwise points at a name of a person or a group of person from the intended recipients list, all fields or parts of the report that the person or group do not have sufficient permissions for, are highlighted.

The user can then indicate the permissions to be granted to the particular recipient or group. The permission can be granted per a report entry or entries, or to the underlying entities within the computerized system which are involved with the field or fields.

After the permissions are indicated by the user creating the report, the permissions are associated with the report or updated in the enterprise computerized system. Optionally, some permissions may be blocked from being granted. For example, an employee cannot be granted permission to view his superiors' salary.

When permissions are granted to system entities, the permission can be limited to the context of the specific report. i.e., the recipient can only view the information via the report. Alternatively, the permission can be global, i.e. the recipient can view the information in other contexts as well.

All granted permissions are stored or otherwise indicated in an appropriate data structure, table or any other location, so that an IT person or anyone else can review the permissions granted in the system, and take an action, such as granting people permanent permission to data, cancelling permissions, tracking the usage of permission, or the like.

When the report is ready, it can be sent by e-mail, as a link, or otherwise shared through the computing system used in the enterprise. Whenever the report is viewed by any of the recipients, live up-to-date information is retrieved from the enterprise systems, and presented to the recipient, subject to the permission. Thus, if one or more permissions are not granted to the recipient, the recipient will view an incomplete report, wherein the areas for which he has no permission are blank, grayed out, or the like. If permission is granted at a later time, the next time the recipient opens the report, he or she will view the relevant information.

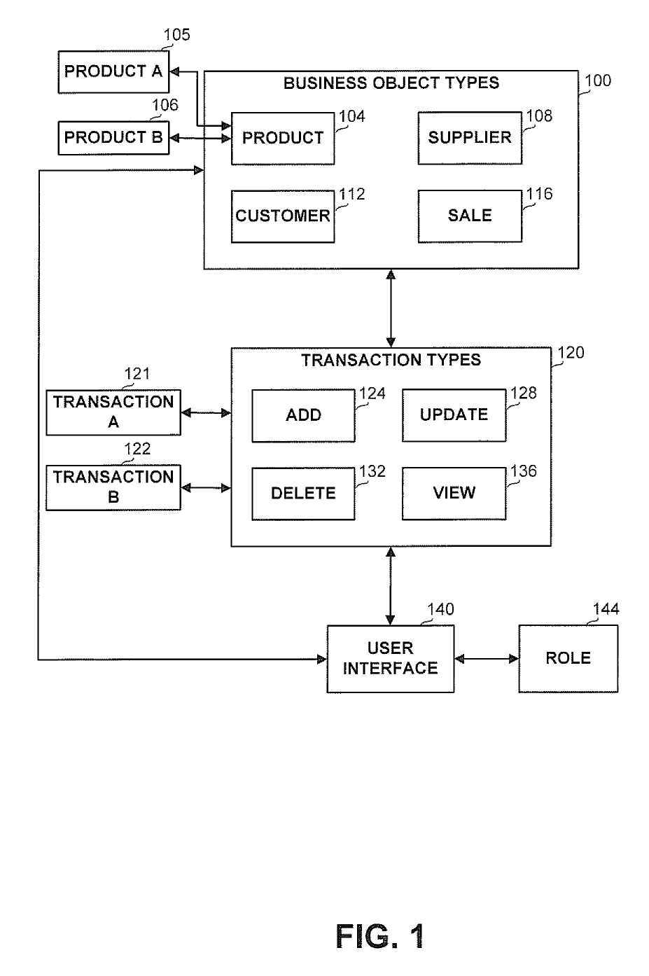

Referring now to FIG. 1, showing the entities in an exemplary enterprise system. The entities are the basic blocks upon which reports or other aggregated data can be constructed, and for which permissions can be granted.

The basic level comprises basic business objects 100, which comprises various types of objects, upon which object instances are created. Thus, in the example shown, business object types include product type 104, suppliers type 108, customer type 112 and sale type 116. Upon each type, multiple object instances can be created, such as product A 105 and product B 106 created upon product type 104, and similarly for other object types.

The next level of objects in the exemplary enterprise system is transactions 120, which may comprise actions such as add 124, update 128, delete 132 or view 136. The actions operate upon, and create, update, or delete object instances of any of object types 100.

A further level is user interface objects 140 which comprise user interface objects for the user to perform one or more of transactions 120. The user interface receives commands from the user, and performs the transactions in accordance with the commands.

User interface objects 140 interact with object types 100, as well as object instances such as product A (105) and product B (106), and with transaction instances such as transaction A (121) or transaction B (122).

User interface objects are also in communication with and relate to role object 144. The permissions of each user depend to a large degree on his or her role, such as a production worker, team-leader, supervisor, department manager, or the like.

It will be appreciated that the objects shown in FIG. 1 are not necessarily programmatic or data objects but are rather associated with real-world objects for which permission can be granted to users. Each object can be implemented by multiple programmatic objects, or one programmatic object can be used to implement multiple objects or object types of FIG. 1. The objects and object types are generally associated with entities in the computerized system of the enterprise, such as database, database tables, records, queries, CRM records, or the like.

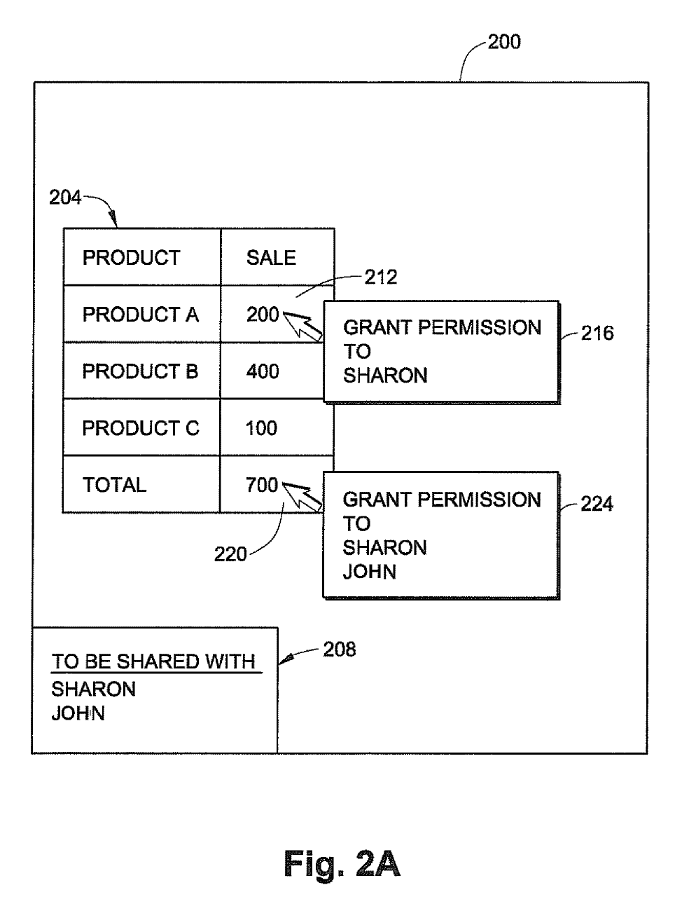

Referring now to FIG. 2A, showing an exemplary implementation of a window or screen displayed to a user creating a report 200 to be shared with additional people. The user creates on screen 200, a table 204 which comprises two columns, a product column and a sales column. Each row in the table refers to a particular product, and there is also a “Total” row.

On area 208 of the screen, or on a separate pane, there is a list of the people or groups with whom the report is to be shared. It will be appreciated that the user is given the option to add or remove recipients from this list, similarly for example to editing a “to” field of an e-mail message. As shown in FIG. 2A, the user entered the names of John and Sharon in area 208. Suppose for example that John is the product manager of product A, while Sharon is the product manager of product B. When the user hovers over entry 212 of table 204, or otherwise points at or accesses entry 212 which comprises the sales of product A, a popup window or pane 216 is opened, indicating Sharon should be granted permission in order to view or affect the entry. In a preferred implementation, separate permission lists may be presented relating to entry 212, table 204, or to the whole report. If the user hovers over or points at entry 220, showing the total of all sales, the opened window or pane 224 indicates that both Sharon and John need to receive permissions in order to view this entry, since initially none of them can view the sales of the other person's product, and hence none can view the total.

Referring now to FIG. 2B, showing another implementation of a window or screen for creating and sharing report 200. When the user clicks on or hovers over a name in area 208, the areas of the report for which the recipient does not have permission are highlighted, using a distinctive background, frame, or the like. For example, if the user clicks on Sharon's name, entries 212 and 220 are highlighted, since as discussed above, Sharon does not have permission for the information in entries 212 and 220.

It will be appreciated that the implementations shown in FIG. 2A and FIG. 2B can be combined, so that clicking on or hovering over a person's name or a group's name in area 208 highlights all areas of the screen which relate to objects for which permissions should be granted for that person or group, and that hovering over a particular area of the screen shows a list of the people or groups out of the recipient list that should be provided permission to view the information in this area. Further, additional manners for presenting or otherwise indicating missing permissions can be used without deviating from the disclosure.

It will be appreciated that if permission is granted for a particular entry or part of the report, the permission is granted for those objects upon which the information in that area is determined. For example, the sales entries may be determined based upon information in object instances of “sale” object type 116 of FIG. 1. However, more complex relationship can exist, in which a single field or area of the report is derived from two or more business objects, or one or more business objects and one or more transaction, or one or more user interface.

In some environments, some predetermined items can be blocked, such that permissions can not be granted for them. For example, an organization can enforce policy wherein personal details or salary details of employees can not be shared with other employees. Such limitations can be visually indicated, for example, by using a predetermined color or message, indicating that such permission can not be granted.

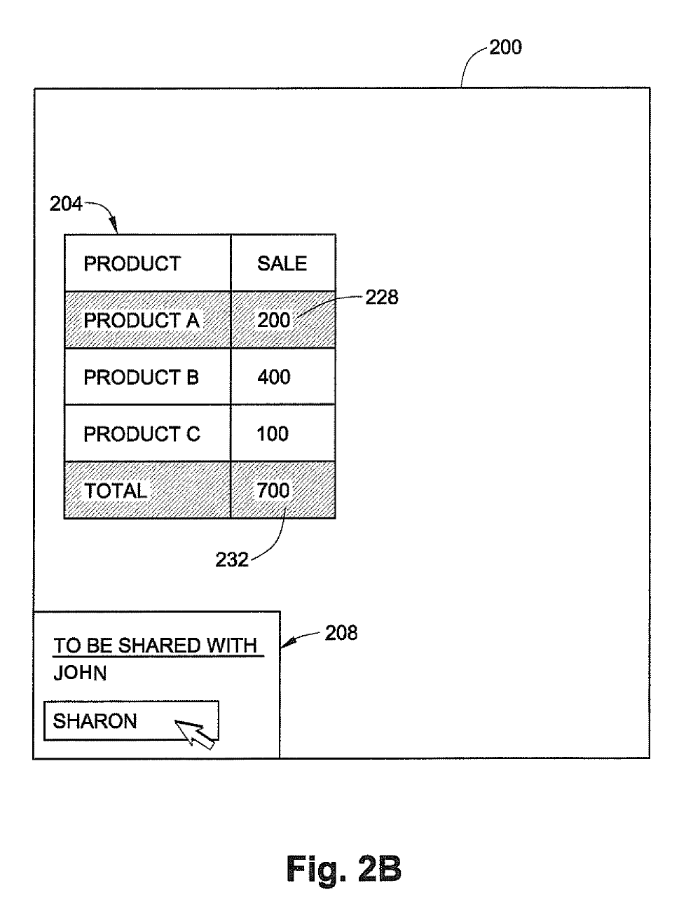

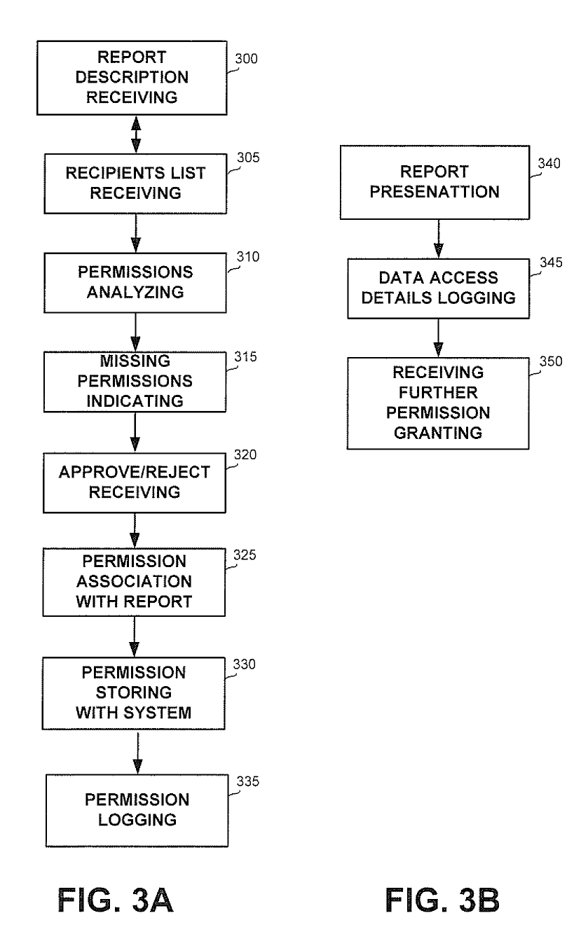

Referring now to FIG. 3A, showing a flowchart of the main steps in a method for granting ad-hoc permissions to people or groups of people.

On step 300 a report description is received from a user. The user is using any tool available in the environment. The tool enables the creation of a report or any other collection of information or activity items, and includes user interface options, as well as connectivity to the computerized environment of the enterprise, including databases, archives, or other data collections, for the purpose of data retrieval or enabling transactions related to the data.

On step 305, a list of people or groups of people is received from the user. The list can be constructed similarly to constructing a recipient list within an e-mail message, i.e. by directly entering an identification field, choosing from a list, receiving suggestions to recently used names, or the like.

It will be appreciated that the report or another representation entity can be generated by one or more persons, and then viewed or modified by another person who also wishes to grant permission to one or more third parties. Thus, step 300 or step 305 can be performed repeatedly, at different times and by different people

During permission analysis step 310, for each field, entry, or any other part of the report, it is determined which underlying object types or object instances, such as the objects detailed in association with FIG. 1 above, are involved. For each of the involved object types or object instances, it is determined whether all the recipients in the recipient list have sufficient permission for these objects. If one or more recipients lack sufficient permission to one or more objects involved in one or more fields of the report, the deficiency is indicated, for example in an internal data structure. Sufficient permission means that the recipient has permission to view all data or perform all activities associated with and enabled by the report. Thus, a recipient may have “read” permission to a particular object, wherein the report requires “update” permission, in which case an insufficient permission will be indicated.

It will be appreciated that when analyzing the permissions, if one or more of the names in the recipient list is a group, then the permissions have to be checked for each individual in the group. It will further be appreciated that the permissions are optionally checked against object types, such as “product” object type, as well as against object instances, such as “product A”. Optionally, if a recipient does not have permission to a particular object type, the permission to the specific instance is not checked at all, in order to save resources. In yet another alternative, the permissions are checked only against the object instances.

Permission analysis step 310 is optionally continuously performed as the report evolves, or as the recipient list changes. Alternatively, step 310 is performed when the user explicitly asks for, for example by hitting a button, a key, a menu entry, or the like.

On missing permission indication step 315, the missing permissions as analyzed on permission analysis step 310 are visually indicated to the user. The indication to the user can be per data item or action, as shown in FIG. 2A above, or per user, as shown in FIG. 2B above, in the form of a table or textual summary, exported to a file, or in any other manner.

On approve/reject permission receiving step 320, the user's decision whether to grant permission or not to the particular recipient for the particular part of the report are received. The user can indicate his or her decision through a popup menu opened on a right mouse click, or in any other way. For example, if during missing permission indication step 315 a file or table were created indicating the missing permissions, the user can associate an approve/reject indication with every missing permission, and then import the text of table back into the report creation system. The permission can also have properties, such as expiration date after which it is no more valid, maximal number of usages before expiration, transfer right, i.e. whether or not the permission can be transferred by a legitimate recipient to a third party, whether the permission is limited to the context of the current report, or other properties. The permission can also be limited to certain activities and is not necessarily total. Thus, permission can be granted to view sales and to add a sale, but not to delete or change an existing sale.

On optional permission association with report step 325, the approved permissions are associated with a report. The association is performed in accordance with the format of the report. For example, the permissions can be added as a data structure, a text file, a configuration parameter, or the like.

On optional permission storing with system step 330, the permissions are stored within the enterprise system, and associated with entities related to the object types or object instances to which the permission relates. If step 330 occurs, then the permissions may be not limited to the context of the report, but the recipient can access the permitted object types and instances using other tools, forms, reports, or the like. Alternatively, the permissions may be stored in the system with an indication of the specific report, so that the recipient's access to the information is limited to viewing or acting with the report.

On permission logging step 335 the permission is optionally logged in a dedicated location and in any required format, so that it people or any other person within the organization can audit the granted permissions.

Referring now to FIG. 3B showing a flowchart of the main steps in a method for presenting the report to a recipient.

On step 340 the report is presented to one or more of the intended recipients. It will be appreciated that the report is not static, but is rather presented with live up-to-date data as retrieved from the data source at viewing time, and not as the data was at the time the report was created. The recipient can see all data for which he or she has permissions, whether they had such permission a-priori, or the permission was granted by the creator of the report. If the recipient does not have permission to one or more parts of the report, these parts are blank, grayed out, or the like.

On data access detail logging step 345, the details of the access to the data permitted by the creator of the report are optionally logged for later tracking of the access to the data. The details may include the identity of the person viewing of acting upon the report, the accessed object type or object instance, date and time, and context, i.e., is the person accessing the data via the report for which he or she got the permission, or in another context.

On receiving further permission granting step 350, the recipient can grant permission to a third party, consisting of one or more persons or groups. The granting is optionally performed according to the steps detailed in association with FIG. 3A above. The further permission granting can be subject to the original creator of the report permitting or forbidding such granting.

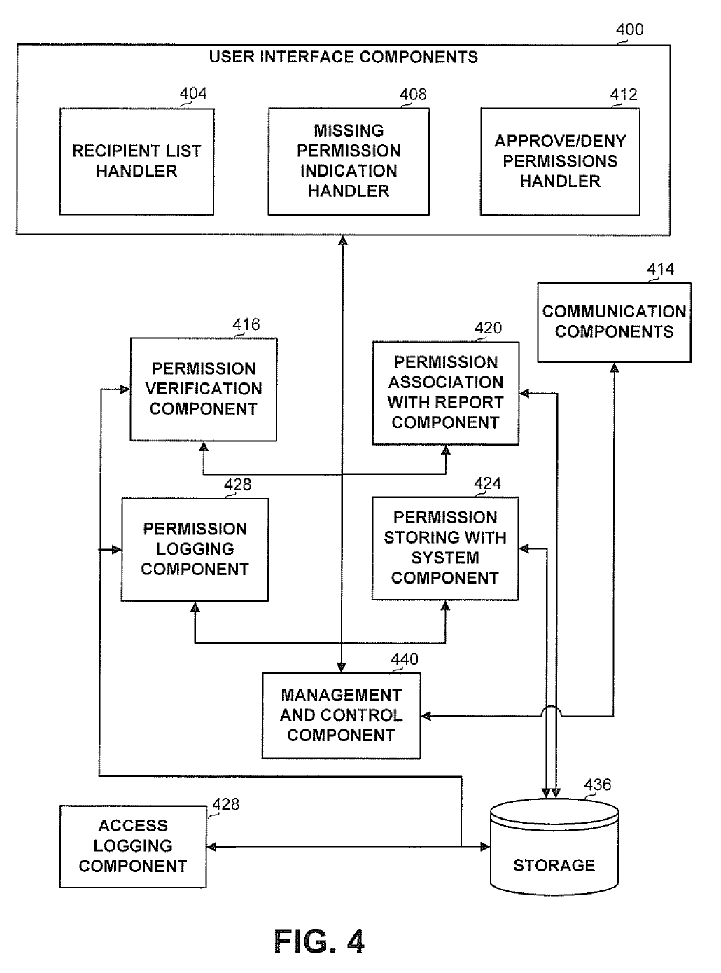

Referring now to FIG. 4, showing a block diagram of the main components in an apparatus for granting ad-hoc permissions. It will be appreciated that the disclosed apparatus is an addition to existing enterprise computerized system, which enables generation of reports as discussed. Each of the components of the disclosed apparatus preferably comprise one or more collections of computer instructions, such as libraries, executables, modules, or the like, programmed in any programming language such as C, C++, C#, Java or others, and developed under any development environment, such as .Net, J2EE or others. The components can be made a part of, or communicate with the report generation system and underlying data systems, databases or the like. The components are executed by a computing platform comprising memory, CPU and one or more I/O ports. The components can be executed by a computing platform which executes the report generation system, or on any other platform in communication with such platform, via local area network (LAN), wide area network (WAN), the internet in a client-server configuration, via a device such as CDROM, disk on key, portable disk or others or the like. The components can be executed on one platform or on multiple platforms wherein data can be transferred from one computing platform to another via any communication channel.

Alternatively, the apparatus can be implemented as firmware ported for a specific processor such as digital signal processor (DSP) or microcontrollers, or can be implemented as hardware or configurable hardware such as field programmable gate array (FPGA) or application specific integrated circuit (ASIC).

The apparatus comprises user interface components 400, take care of the visual parts of the system, through which the user provides and receives information to or from the system. User interface components 400 comprise recipient list handler 404 for handling the recipient list for which the report is intended, and missing permission indication handler 408, for indicating missing permissions associated with the report. The indication can be in the form of a floating window, highlighted parts of the report, a presented text or table report, or the like. User interface components further comprise approve/deny permission handler 412 for enabling the user to indicate whether permission is to be granted and optionally the properties of the permission, and for receiving the user's response.

The apparatus further comprises communication components 414, which may comprise a component for communicating with the report generation system, a component for communication with database systems, e-mail systems, or any other system external to the apparatus.

The apparatus further comprises permission verification component 416 which receives one or more data items associated with the report, and one or more recipient indications, and determines which object types and object instances the data item is associated with, and determines whether the recipient has sufficient permission to all the object types and object instances.

Another component of the apparatus is permission association with report component 420, for associating the granted permissions and their properties with the report, according to the manner at which the report persistency is maintained, and permission storing with system component 424 for indicating the permissions and their properties with the enterprise system, such as database, for example by associating or storing the permission in association with the relevant object types or object instances.

The apparatus further comprises permission logging component 428 for storing the permission as well as other ad-hoc permissions granted, for tracking, auditing statistics or other purposes.

The apparatus also comprises access logging component 432 for logging accesses of recipients to data which were enabled only due to permissions granted ad-hoc. The logging comprises the details of the recipient, the accessed data, date and time, the viewing context and possibly additional data.

All permission data, access data, and optionally additional data is stored in storage 440, which is preferably a mass storage device, for example an optical storage device such as a CD, a DVD, or a laser disk; a magnetic storage device such as a tape or a hard disk; a semiconductor storage device such as Flash device, memory stick, or the like. Storage 440 can be the same storage device used for other functions in the organization, such as storing the report, the underlying databases or the like. Alternatively, it can be an independent storage device, which can communicate information to or from other storage devices in the organization.

Yet another component of the system is management and control component 440 which is responsible for managing the flow of control and information among the other components, and between the apparatus components and external system.

It will be appreciated by persons skilled in the art that the apparatus as detailed is exemplary only, and that additional, fewer, or different components can be designed and used for the same purpose. Functionality associated with a particular component can be split between multiple components, while certain components can provide functionalities used by other components as well.

The disclosure relates to a method and apparatus for granting ad-hoc permissions to people, to views and act upon privileged information within an organization. The method and apparatus enable a user creating a report to grant permission to a person who generally does not have such permission to view or act upon data items. The apparatus and method enable the recipient to view the report with up-to-date data as retrieved from the data source in viewing time, rather than stale data frozen at creation time. The method and apparatus also provide for permission granting logging and monitoring, so as to enable tracking the people or groups exposed to the information.

It will be appreciated by persons skilled in the art that the present invention is not limited to what has been particularly shown and described hereinabove. Rather the scope of the present invention is defined only by the claims which follow.

What is claimed is:

1. A method for sharing information between users of a computerized system, the method comprising the steps of:
receiving a description of a report comprising at least one field;
receiving a recipient list of the report;
a permission analysis step, comprising:
determining at least one object type or object instance associated with the at least one field;
determining at least one recipient from the recipient list that has insufficient permission for the at least one object type or object instance;
providing a visual indication of the at least one field; receiving an approval for granting a permission to the recipient for the at least one field or for the at least one object type or object instance; associating the permission with the report;
logging the permission; and
presenting the report to the at least one recipient, including the at least one field.

2. The method of claim 1 further comprising the step of storing the permission in association with the at least one object type or object instance.

3. The method of claim 1 further comprising the step of associating the permission with the report.

4. The method of claim 1 further comprising the step of logging access details of the at least one recipient to the at least one object type or object instance.

5. The method of claim 1 wherein the visual indication indicates the at least one recipient.

6. The method of claim 1 wherein the permission is associated with a property.

7. The method of claim 6 wherein the property is selected from the group consisting of: expiration date; usage limitation; transfer rights; and context limitation.

8. The method of claim 1 further comprising the step of receiving further permission granting from the at least one recipient to a third party.

9. The method of claim 1 wherein the permission is provided ad-hoc.

10. An apparatus for sharing information between users of a computerized system, the users having different permissions, the apparatus comprising:
user interface components for providing and receiving information to and from a user of the apparatus, the user creating or viewing a report;
communication components for communicating with external systems;
a permission verification component for determining an at least one object type or object instance for which a recipient of the report does not have sufficient permission;
a storage device for storing the permission; and
a permission logging component for logging the permission on the storage device.

11. The apparatus of claim 10 further comprising a component for storing the permission in a storage device associated with the computerized system.

12. The apparatus of claim 10 further comprising a component for associating the permission granted to the recipient for the at least one object type or object instance, with the report.

13. The apparatus of claim 10 wherein the communication components comprise at least one component for communicating with a system selected from the group consisting of: a database; a report creation system; and an e-mail system.

14. The apparatus of claim 10 wherein the user-interface components comprise at least one component selected from the group consisting of: recipient list handler; missing permission indication handler; and approve or deny permission handler.

15. The apparatus of claim 10 further comprising a permission association with report component, for associating a permission granted to the recipient for the at least one object type or object instance, with the report.
